(19) United States
(12) Patent Application Publication
(10) Pub. No.: US 2007/0081209 A1
(43) Pub. Date: Apr. 12, 2007

(54) Image display device

(75) Inventor: Minoru Wada, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/544,670

(22) Filed: Oct. 10, 2006

(30) Foreign Application Priority Data
Oct. 11, 2005 (JP) 2005/296216
Mar. 14, 2006 (JP) 2006/068511

(51) Int. Cl. G02B 5/32

(52) U.S. Cl. 359/15

(57) ABSTRACT

An image display device provided with a rectangular panel having a substrate 6 composed of glass or resin, a foreside laminated body 2 provided on the viewer side of the substrate 6 and a backside laminated body 7 provided on the backside of the substrate 6, wherein the foreside laminated body 2 has a polarizer 4, and the absorption axis 9 of the polarizer 4 is parallel to the short edge direction of the panel 1.

### BACKGROUND OF THE INVENTION

1. Field of the Invention

The present invention relates to an image display device such as a flat panel display, in particular, to an image display device useful for a liquid crystal display device for use in a monitor of a personal computer, a television or the like.

2. Background Art

Recently, various types of image display devices such as a liquid crystal display device, an organic electroluminescence (organic EL) display device and a PDP have been developed. The application of these ranges widely and, recently, development is proceeding from the application for a monitor of a personal computer, further, to the application for TV. Along with this, development of a large size screen proceeds.

As well as a large size screen, reduction in the thickness of a whole image display device also proceeds. The reduction in the thickness of an image display device can be achieved by constituting an image display device using a panel provided with a substrate made of thin glass or resin, but there is such problem that warpage easily occurs in such panel, that is, the center portion of the panel dishes and the fringe portion warpages to the foreside, when viewed from the foreside (viewer side) of the image display device. When such warpage occurs, the fringe portion, or four corners of the panel may contact to a casing, which gives an adverse affect on picture display performance.

The aforementioned warpage of a panel is caused by the fact that, relative to a substrate made of glass or resin which does not generate warpage in nature, various types of members laminated on the viewer side and the backside thereof (hereinafter, the backside relative to the viewer side is occasionally referred to as “a backside” simply) generate expansion/contraction due to heating and moisture absorption/desorption to result in difference in the degree of expansion/contraction between the viewer side and backside, thereby disrupting a balance of forces between fore- and back-sides of an image display device. In an ordinary image display device, the viewer side surface of the panel is opened, but the backside is assembled in a casing to become in a quasi sealed state. Consequently, difference occurs in heating and moisture absorption/desorption between the foreside laminated body and the backside laminated body to result in occurrence of difference in expansion/contraction, too.

Taking a liquid crystal display device as an example, a liquid crystal display device is manufactured by arranging polarizing plates for producing polarized light on both sides of a liquid crystal cell in which liquid crystal is sealed between glass substrates, laminating various optical elements such as a retardation plate, an antireflection film or a brightness-enhancing film according to need, fixing the periphery thereof with a fixing frame composed of a metallic plate such as stainless steel plate, which is called a “bezel,” to form a liquid crystal module, and assembling and housing the liquid crystal module with other constitutional members in a casing.

According to such reason that, temperature rises due to a backlight when a light source switch of a liquid crystal display device is on, sometimes difference in temperature or humidity may occur between the foreside (viewer side) and the backlight side. In this case, it is considered that the foreside laminated body and backlight side laminated body including a polarizing plate are exposed to different temperature or humidity conditions while taking the liquid cell as a boundary, and that respective laminated bodies are subjected to the influence. When warpage occurs, the fringe portion or 4 corners of a panel not only contact to the casing, but also stick fast to the backlight arranged on the backside to generate display performance problems. Further, a “corner unevenness” phenomenon in which light leaks unevenly from 4 corners of a panel (screen) when the screen is in black level of display, which sometimes causes a very large problem in display performance.

In order to improve warpage of a panel due to environmental alteration, in JP-A-2003-149634, in a liquid crystal display device prepared by arranging polarizing plates composed of a polarizer with a protective film on both sides of a liquid crystal cell and further laminating a brightness enhancing film to the backside polarizing plate, thicknesses of the protective film used for the foreside polarizing plate and the protective film used for the backside polarizing plate are set to be not equal. However, when the protective film of the laminated body on the viewer side arranged on the foreside is thinned, there was such problem that the polarizer tends to easily deteriorate due to humidity to lower optical performances.

### SUMMARY OF THE INVENTION

The purpose of the present invention is to provide an image display device in which warpage of a panel is prevented and lowering in display performance is suppressed.

The inventors of the invention found that, when a liquid crystal display device is left in a high temperature and humidity for a certain period and then moved in ordinary temperature and humidity, particularly the foreside laminated body having been more strongly exposed to the high temperature and humidity contracts to disrupt the balance between forces of the fore- and back-sides of the panel and warpage occurs, and that the contraction of the foreside laminated body mainly occurs due to the contraction of the polarizer constituting the foreside laminated member.

As the result of further investigations, the inventors found that, when left under a high humidity, the polarizer of polarizing plate of the laminated member on the viewer side contains moisture to lower the glass transition temperature thereof, and that, in order to relax the stress, it more largely contracts in the stretching axis direction stretched at the film forming of the polarizer, that is, in the absorption axis direction compared with the direction crossing perpendicular to the absorption axis direction.

Consequently, the inventors found that, when a panel is mounted in an image display device, warpage of the panel can be prevented by setting the absorption axis direction of a polarizer with a large contraction being a laminated member arranged on the viewer side to parallel to the short edge direction of the panel, instead of setting it to parallel to the long edge direction of the panel.

Specifically, the aforementioned problem can be solved by the following means.

(1) An image display device provided with a rectangular panel having a substrate composed of glass or resin, a foreside laminated body provided on the viewer side of the substrate and a backside laminated body provided on the backside of the substrate, wherein the foreside laminated body has a polarizer, and the absorption axis of the polarizer is parallel to the short edge direction of the panel.

(2) The image display device according to item (1) having a retardation film on the viewer side of the foreside laminated body.

(3) The image display device according to item (2), wherein a protective film provided on the viewer side of the foreside laminated body works as the retardation film.

(4) The image display device according to any of items (1)-(3) having at least one layer selected from the group consisting of an antiglare layer, a light scattering layer, a light-scattering antireflection layer and a light-scattering hard coat layer on the viewer side of the foreside laminated body.

(5) The image display device according to any of items (1)-(4), wherein the ratio of the short edge relative to the long edge (short edge/long edge) of the panel is 0.85 or less.

(6) The image display device according to any of items (1)-(5), wherein the long edge of the panel is 40 cm-350 cm.

(7) The image display device according to any of items (1)-(6), wherein the foreside laminated body and the substrate are laminated via an adhesive layer and the thickness of the adhesive layer is 30 μm-100 μm.

(8) The image display device according to any of items (1)-(7), wherein the surface of the panel on the viewer side is opened and the backside of the panel is closed with a casing.

(9) The image display device according to any of items (1)-(8), wherein the substrate is a liquid crystal cell and the backside laminated body includes an optical compensatory film.

(10) The image display device according to item (9), wherein the polarizer has a viewer side protective film provided on the viewer side and a substrate side protective film provided on the substrate side, and at least one of the viewer side protective film and the substrate side protective film is composed of cellulose acylate.

(11) The image display device according to any of items (1)-(10) employing the liquid crystal display mode of VA system or IPS system.

(12) The image display device according to any of items (1)-(11) employing the liquid crystal display mode of TN system or OCB system.

According to the invention, it is possible to provide an image display device in which warpage of a panel is prevented to suppress the degradation of display performance.

### BRIEF DESCRIPTION OF THE DRAWINGS

FIG. 1 is a cross-sectional view showing a constitution example of the image display device of the present invention.

FIG. 2 is a plan view showing the relation between the short edge of the panel and the absorption axis of the polarizer.

### BEST MODE FOR CARRYING OUT THE INVENTION

Hereinafter, the image display device of the present invention will be described in detail. The following description about the constitutional features is occasionally based on the typical embodiment of the invention, but the invention is not restricted to such embodiment. The numerical range represented by using “−” herein means a range including numerical values described before and after “−” as the lower limit and the upper limit, respectively. The term “parallel” herein means that an angle between 2 directions is 0°±1°, and “perpendicular” and “orthogonal” mean that an angle between 2 directions is 90°±1°.

(Constitution of Image Display Device)

The image display device of the invention is provided with a rectangular panel having a substrate composed of glass or plastic, a foreside laminated body provided on the viewer side of the substrate and a backside laminated body provided on the backside of the substrate. It is characterized that the foreside laminated body has a polarizer, and the absorption axis of the polarizer is parallel to the short edge direction of the panel. To the polarizer, a viewer side protective film can be provided on the viewer side thereof, and a substrate side protective film can be provided on the substrate side thereof, wherein at least on of the viewer side protective film and the substrate side protective film is preferably constituted of cellulose acylate.

The panel constituting the image display device of the invention may be provided with another optical film or functional layer according to need. The panel is preferably disposed in the image display device so that the surface of the viewer side is opened and the rear face is closed with a casing.

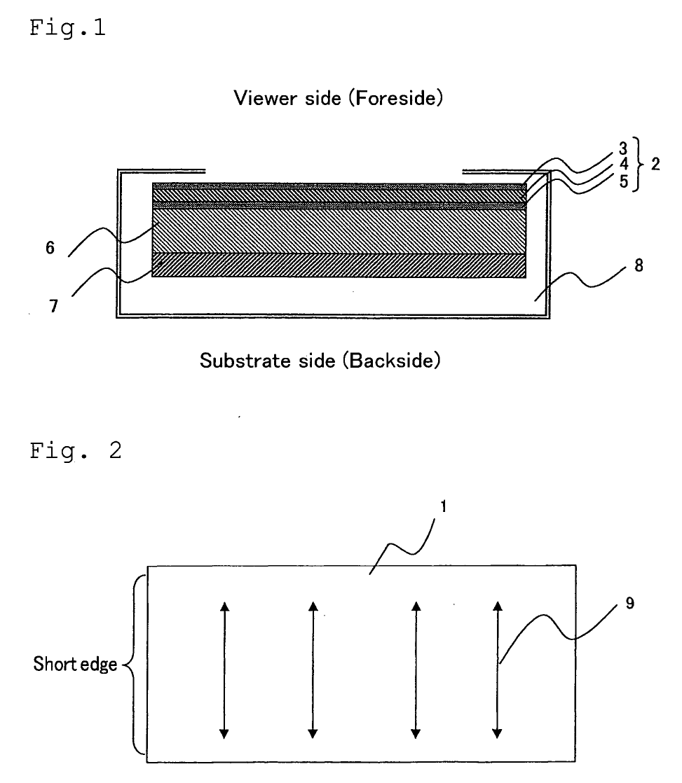

A constitution example of the image display device of the invention is shown in FIG. 1. In FIG. 1, the image display device of the invention is constituted by mounting a panel 1 in a casing 8, wherein the surface of the viewer side (upside on the paper) of the panel 1 and the backside (downside on the paper) is sealed with the casing 8.

The panel 1 is constituted of a foreside laminated body 2, a substrate 6 and a backside laminated body 7, and has a rectangular shape when viewed from the upside on the paper. The foreside laminated body 2 has the constitution formed by laminating a viewer side protective film 3, a polarizer 4 and a substrate side protective film 5.

Next, while referring to FIG. 2, the relation between the absorption axis of the polarizer and the panel in the invention will be described. As shown in FIG. 2, the panel 1 has a rectangular shape when viewed from the viewer direction shown in FIG. 1, and, in the image display device of the invention, the short edge direction of the panel 1 and an absorption axis 9 of the polarizer are parallel to each other. By disposing the polarizer to the panel in this way so that the short edge direction of the panel 1 and the absorption axis 9 of the polarizer become parallel to each other, warpage of the panel can be prevented.

Hereinafter, the image display device will be described while mentioning a liquid crystal display device as a main example. However, the image display device of the invention is not restricted to a liquid crystal display device.

A “liquid crystal display device” has a construction in which a liquid crystal cell constituting a substrate is disposed with polarizing plates on both sides thereof, and, according to need, various types of optical elements such as a retardation film, an antireflection film and a luminance-improving film are laminated thereon. The substrate in the invention corresponds to a liquid crystal cell in the case of a liquid crystal display device, and respective laminated bodies correspond to various types of optical elements such as a polarizing plate, a retardation film, an antireflection film and a luminance-improving film.

In general, a liquid crystal display device is produced by fixing the periphery portion of a liquid crystal panel with a fixing frame composed of a metal plate such as stainless steel, which is referred to as a “bezel,” to form a liquid crystal module, and mounting and housing the liquid crystal module in a casing with other constitutional members. It can be used also in the invention in the same constitution.

(Substrate)

The substrate constituting the image display device of the invention is composed of glass or resin (plastic). The glass or resin may contain an additive. Further, the substrate may hold a constitutional element other than glass or resin. The “substrate” used herein means a plate that holds a liquid crystal layer in the case of a liquid crystal display device, or a plate that holds a luminant in the case of an organic EL and PDP.

For example, when the substrate is a liquid crystal cell of a liquid crystal display device, glass or resin usually used for this application can be adopted as a constitutional element. Then, liquid crystal can be sealed between cell substrates composed of glass or resin. On both sides of the liquid crystal, transparent conductive films can be provided, and further, on the foreside (viewer side) of the transparent conductive film, a color filter can be provided. From the viewpoint of reducing the thickness of a liquid crystal display device, the substrate has a thickness of preferably 1 mm or less, more preferably 0.7 mm or less, most preferably 0.5 mm or less. There is no particular restriction on the dimensions, but, since warpage of a liquid crystal panel easily occurs when the area is wide, the invention is particularly effective when it is used for a liquid crystal display device with a large screen.

The material for the resin substrate is not particularly restricted and all of conventionally publicly known materials can be employed when they have transparency and mechanical strength. Examples of the resin for forming the resin substrate include thermoplastic resins such as polycarbonate, polyarylate, polyether sulfone, polyester, polysulfone, polymethyl methacrylate, polyetherimide and polyamide, and thermosetting resins such as epoxy-based resin, unsaturated polyester, polydiallyl phthalate and polyisobornyl methacrylate. Such resins may be used in 1 type or in combination of 2 or more types, or also as a copolymer or mixture with another ingredient.

(Foreside Laminated Body)

Next, the foreside laminated body in a liquid crystal display device will be described. The foreside laminated body includes at least a polarizer and functions as a polarizing plate.

In the invention, the type of a polarizing plate is not particularly restricted when it satisfies the condition of the invention. For example, an absorption type polarizing plate, which is manufactured by laminating a polarizer prepared by soaking a polyvinyl alcohol (PVA) film with iodine having dichroic property or a dichroic dye, stretching it to align followed by cross-linking and drying, and a protective film such as a triacetylcellulose (TAC) film, can be preferably used. As a polarizer, one having an excellent optical transmittance and polarization degree is preferred. The optical transmittance is preferably 30%-50%, further preferable 35%-50%, most preferably 40% -50%. The polarization degree is preferably 90% or more, further preferably 95% or more, most preferably 99% or more. A transmittance of 30% or less, or a polarization degree of 90% or less results in a low brightness or contrast of an image display device, which lowers display quality level. The thickness of the polarizer is preferably 1-50 μm, further preferably 1-30 μm, most preferably 8-25 μm.

The polarizer can have a viewer side protective film provided on the viewer side and a substrate side protective film provided on the substrate side. At least one of the viewer side protective film and the substrate side protective film is preferably composed of cellulose acylate.

In the invention, adhesion treatment of the polarizer and respective protective films is not particularly restricted, and can be effected via, for example, an adhesive composed of vinyl alcohol-based polymer, or an adhesive at least composed of a water-soluble cross-linking agent of vinyl alcohol-based polymer such as boric acid or borax, glutaraldehyde or melamine, or oxalic acid. In particular, from the viewpoint of the best adhesiveness with a polyvinyl alcohol-based film, the use of a polyvinyl alcohol-based adhesive is preferred. Such adhesive layer can be formed as a coated and dried layer of an aqueous solution, or the like. When the aqueous solution is prepared, other additives and a catalyst such as an acid can be blended according to need.

As the material forming respective protective films, a polymer excellent in optical performance, transparency, mechanical strength, thermal stability, moisture-blocking performance, isotropy and the like is preferred. For example, polycarbonate-based polymers, polyester-based polymers such as polyethylene terephthalate and polyethylene naphthalate, acrylic polymers such as polymethyl methacrylate, and styrene-based polymers such as polystyrene and acrylonitrile-styrene copolymer (AS resin) can be mentioned. Further, the example includes polyolefins such as polyethylene and polypropylene, polyolefin based-polymers such as ethylene-propylene copolymer, vinyl chloride-based polymers, amide-based polymers such as nylons and aromatic polyamides, imide-based polymers, sulfone-based polymers, polyether sulfone-based polymers, polyether ether ketone-based polymers, polyphenylene sulfide-based polymers, vinylidene chloride-based polymers, vinyl alcohol-based polymers, vinyl butyral-based polymers, arylate-based polymers, polyoxymethylene-based polymers, epoxy-based polymers, and polymer mixtures of above-mentioned polymers. Further, respective protective films used in the invention may be also formed as a hardened layer of an ultraviolet ray-setting type or a thermosetting type resin such as acrylic, urethane-based, acrylic urethane-based, epoxy-based or silicone-based resins.

In the invention, as a material for forming respective protective films, thermoplastic norbornene-based resin can be preferably used. AS the thermoplastic norbornene-based resin, ZEONEX and ZEONOR manufactured by ZEON CORPORATION, and ARTON manufactured by JSR can be mentioned.

In addition, as the material for forming respective protective films, cellulose-based polymer such as cellulose acylate represented by triacetyl cellulose, which is excellent in laminating property with a polarizer and has been conventionally used as a transparent protective film of a polarizing plate, can be also used preferably.

Respective protective films for use in the invention may be film-formed by thermofusion of a thermoplastic polymer resin, or by solution film-forming from a solution uniformly dissolving a polymer (solvent casting method). In the case of the thermofusion film-forming, various additives (e.g., a compound for lowering optical anisotropy, wavelength dispersion controlling agent, ultraviolet rays protective agent, plasticizer, deterioration inhibitor, fine particles, optical property-adjusting agent) can be added at the thermofusion. On the other hand, when preparing the protective film from a solution, to the polymer solution (hereinafter, referred to as a “dope”), various additives (e.g., a compound for lowering optical anisotropy, wavelength dispersion controlling agent, ultraviolet rays protective agent, plasticizer, deterioration inhibitor, fine particles, optical property-adjusting agent) corresponding to applications can be added in respective preparation processes. As to the timing of the addition, any step in dope formation is allowable, and the step may be the last step of the dope formation.

—Foreside Laminated Body Including Polarizing Plate—

The foreside laminated body of a liquid crystal display device includes a polarizing plate and, further, can also include optical members to be adhered on the viewer side and liquid crystal cell side (substrate side) of the polarizing plate.

To the protective film of the polarizer on the liquid crystal cell side (substrate side protective film), an optical compensatory film may be used according to need. An optical compensatory film generally indicates an optical material for compensating view angles of a liquid crystal display device in oblique directions, and is the same meaning as a retardation plate and an optical compensatory sheet. The optical compensatory film may be of an integrated type formed by giving optical compensatory performance to the protective film itself of the polarizing plate, for example, it may be a triacetylcellulose acylate film given an optical compensatory performance to form a protective film of a polarizer. For example, it may be a triacetylcellulose film coated with discotic liquid crystal and then integrated with a polarizing plate.

When an optical compensatory film is provided to the backside laminated body, for a protective film on the liquid crystal cell side of the polarizer of the foreside laminated body (substrate side protective film), a protective film having a small anisotropy of refractive index (not different in the plane direction and thickness direction) may be used.

The thickness of the viewer side protective film and the substrate side protective film is preferably 20 μm-150 μm. More preferably, it is 30 μm-130 μm.

The aforementioned material can be employed as the protective film on the viewer side of polarizer, but, by selecting a protective film having retardation, even when a viewer looks at an image display device while wearing polarized glasses, such phenomenon that the displayed screen is greatly darkened not to allow images to be discriminated can be prevented. The retardation of the retardation film is preferably around 100 nm-300 nm. The direction of the slow phase axis of the retardation film is preferably about 45° relative to the direction of the absorption axis of polarizer. Such retardation film may be provided independently of the protective film.

On the viewer side of the foreside laminated body (in particular, the surface of the protective film on the viewer side provided on the polarizer), at least one layer selected from the group consisting of an antiglare layer, a light scattering layer, a light-scattering antireflection layer and a light-scattering hard coat layer is preferably provided. By providing these layers, when displayed images are viewed while wearing polarized glasses, such phenomenon that dark and light, or interference color is observed on the displayed screen, display becomes bad, and that displayed color is observed as different color, can be prevented.

In the invention, it is preferred that an antireflection layer prepared by laminating at least a light scattering layer and low refractive index layer in the order, or an antireflection layer prepared by laminating a middle refractive index layer, high refractive index layer and low refractive index layer in the order is provided on the protective film of the polarizing plate. The layer of the former constitution generally gives a mirror reflectivity of 1% or more and is referred to as a Low Reflection (LR) film. The latter constitution can give a layer realizing a mirror reflectivity of 0.5% or less, which is referred to as an Anti Reflection (AR) film. Hereinafter, an LR film and an AR film will be described in detail.

(1) LR film

Preferable examples of an antireflection layer (LR film) prepared by disposing a light scattering layer and low refractive index layer on the protective film of the polarizing plate will be described.

Mat particles are preferably dispersed in the light scattering layer, the refractive index of materials other than the mat particles in the light scattering layer is preferably in the range of 1.50-2.00, and the refractive index of the low refractive index layer is preferably in the range of 1.20-1.49. In the invention, the light scattering layer has both of antiglare property and hard coat property, and may be constituted of one layer or plural layers, for example, 2-4 layers.

When the antireflection layer is designed so as to have such concavo-convex surface shape that a center line average roughness Ra is 0.08-0.40 μm, a ten point average roughness Rz is 10 times Ra or less, an average concave-convex distance Sm is 1-100 μm, the standard deviation of heights of convex portions from the concavo-convex deepest portions is 0.5 μm or less, the standard deviation of average concave-convex distances Sm based on center lines is 20 μm or less, and planes with a tilt angle of 0-5° exist in 10% or more, sufficient antiglare property and visually uniform mat feeing can be achieved, which is preferred.

When hue of reflected light under a C light source has an a* value of −2 to 2 and a b* value of −3 to 3, and ratio of the minimum reflectivity to the maximum reflectivity in the range of 380 nm-780 nm is 0.5-0.99, the hue of reflected light becomes neutral, which is preferred. Further, when the b* value of transmitted light under a C light source is set to 0-3, yellowish hue at white display when the antireflection layer is applied to a display device is reduced, which is preferred. Furthermore, when the standard deviation of luminance distribution upon measuring the luminance distribution on a film while inserting a lattice of 120 μm×40 μm between a surface light source and the antireflection layer is set to 20 or less, glare that occurs when the polarizing plate of the invention is applied to a high-definition panel is reduced, which is preferred.

When optical properties of the antireflection layer adoptable for the invention are configured to have a mirror reflectivity of 2.5% or less, a transmittance of 90% or more and a 60° glossiness of 70% or less, reflection of outside light can be suppressed to improve visibility, which is preferred. In particular, the mirror reflectivity is more preferably 1% or less, most preferably 0.5% or less. When it is configured so as to have a haze of 20%-50%, a ratio of internal haze value/total haze value of 0.3-1, a lowering in a haze value of 15% or less due to formation of the low refractive index layer on the light scattering layer, a sharpness of a transmitted image of 20%-50% at a comb width of 0.5 mm, and a ratio of vertical transmittance/transmittance of a direction inclined from the vertical direction in 2° of 1.5-5.0, prevention of glare and reduction of blur of characters and the like on a high-definition LCD panel are achieved, which is preferred.

—Low Refractive Index Layer—

The refractive index of the low refractive index layer usable to the invention is in the range of preferably 1.20-1.49, further preferably 1.30-1.44. Further, the low refractive index layer preferably satisfies the following formula in point of lowering the reflectivity:
(m/4)λ×0.7<nLdL<(m/4)λ×1.3
wherein m is a positive odd number, nL is the refractive index of the low refractive index layer, and dL is the thickness (nm) of the low refractive index layer. λ represents a wavelength, having a value in the range of 500-550 nm.

Materials for forming the low refractive index layer will be described below.

The low refractive index layer preferably includes a fluorine-containing polymer as a low refractive index binder.

As the fluorine-containing polymer, such fluorine-containing polymer is preferred that is crosslinkable by heat or ionizing radiation having a dynamic friction coefficient of 0.03-0.20, a contact angle relative to water of 90-120° and a slip angle of pure water of 70° or less. When the polarizing plate according to the invention is mounted in an image display device, a lower peel force between a commercially available adhesion tape is preferred because a sticker or memo paper is easily peeled off after sticking. When measured with a tension tester, the peel force is preferably 500 gf or less, more preferably 300 gf or less, most preferably 100 gf or less. Further, a higher surface hardness measured with a microhardness meter gives a surface that is less bruised, thus the surface hardness is preferably 0.3 GPa or more, more preferably 0.5 GPa or more.

As the fluorine-containing polymer for use in the low refractive index layer, there can be mentioned hydrolysates and dehydration condensates of perfluoroalkyl group-containing silane compounds (e.g., (heptadecafluoro-1,1,2,2-tetrahydrodecyl)triethoxysilane) and, in addition, fluorine-containing copolymer including a fluorine-containing monomer unit and a constitutional unit for giving it crosslinking reactivity as constitutional components.

Specific examples of the fluorine-containing monomer include fluoroolefins (such as fluoroethylenel vinylidene fluoride, tetrafluoroethylene, perfluorooctylethylene, hexafluoropropylene, perfluoro-2,2-dimethyl-1,3-dioxol), partially or totally fluorinated alkyl ester derivatives of (meth)acrylic acid (such as VISCOAT 6FM, manufactured by OSAKA ORGANIC CHEMICAL INDUSTRY LTD.; M-2020, manufactured by DAIKIN INDUSTRIES, ltd.) and totally or partially fluorinated vinyl ethers. Preferable ones are perfluoroolefins, wherein hexafluoropropylene is particularly preferred from such viewpoints as the refractive index, solubility, transparency and availability.

As the constitutional unit for giving it crosslinking reactivity, there can be mentioned a constitutional unit obtained by polymerization of monomer previously having a self-closslinkable functional group in a molecule such as glycidyl (meth)acrylate and glycidyl vinyl ether, a constitutional unit obtained by polymerization of monomer having a carboxyl group, a hydroxyl group, an amino group or a sulfo group (such as (meth)acrylic acid, methylol (meht)acrylate, hydroxyalkyl (meth)acrylate, allyl acrylate, hydroxyethylvinyl ether, hydroxybutylvinyl ether, maleic acid or crotonic acid), and a constitutional unit formed by introducing a crosslinkable reactive group such as a (meth)acryloyl group into these constitutional units through polymer reaction (e.g., it can be introduced by such method as acting acryloyl chloride on a hydroxyl group).

In addition to the fluorine-containing monomer unit and the constitutional unit for giving it crosslinking reactivity, monomer containing no fluorine atom can be suitably copolymerized from such viewpoint as solubility in a solvent and transparency of the film. There is no particular restriction on monomer units that can be used in combination, and examples thereof include olefins (such as ethylene, propylene, isoprene, vinyl chloride, vinylidene chloride), acrylic acid esters (such as methyl acrylate, ethyl acrylate, 2-ethylhexyl acrylate), methacrylic acid esters (such as methyl methacrylate, ethyl methacrylate, butyl methacrylate, ethylene glycol dimethacrylate), styrene derivatives (such as styrene, divinylbenzene, vinyl toluene, α-methylstyrene), vinyl ethers (such as methylvinyl ether, ethylvinyl ether, cyclohexylvinyl ether), vinyl esters (such as vinyl acetate, vinyl propionate, vinyl cinnamate), acrylamides (such as N-t-butylacrylamide, N-cyclohexylacrylamide), methacrylamides, and acrylonitrile derivatives.

For the aforementioned polymer, a hardening agent may be suitably used in combination as described in JP-A-10-25388 and JP-A-10-147739.

—Light Scattering Layer—

The light scattering layer is formed for the purpose of giving light scattering property due to at least either of surface scattering or internal scattering and hard coat property for improving abrasion resistance of the film to the film. Therefore, it is formed while including a binder for giving hard coat property and mat particles for giving light scattering property to the film, and, according to need, an inorganic filler for increasing the refractive index, preventing crosslink contraction and increasing strength of the film. In addition, such light scattering layer also functions as an antiglare layer, thus resulting in providing the polarizing plate with an antiglare layer.

The thickness of the light scattering layer is preferably 1-10 μm, more preferably 1.2-6 μm for the purpose of giving hard coat properties to the film. The thickness of the lower limit or more hardly leads to such problem as insufficiency of hard coat properties, and that of the upper limit or less hardly leads to such disadvantage as insufficiency of processability due to degradation of curl or brittleness, which are preferred.

The binder for the light scattering layer is preferably a polymer having a saturated hydrocarbon chain or polyether chain as the main chain, further preferably a polymer having a saturated hydrocarbon chain as the main chain. The binder polymer preferably has a crosslinked structure. As the binder polymer having a saturated hydrocarbon chain as the main chain, a polymer of an ethylenic unsaturated monomer is preferred. As the binder polymer having a saturated hydrocarbon chain as the main chain and crosslinked structure, a (co)polymer of a monomer having 2 or more ethylenic unsaturated groups is preferred. In order to make the binder polymer have a high refractive index, a monomer, which includes an aromatic ring or at least one type of atom selected from halogen atoms other than fluorine, sulfur atom, phosphorous atom and nitrogen atom, may also be selected.

Examples of the monomer having 2 or more ethylenic unsaturated groups include esters of polyhydric alcohol and (meth)acrylic acid (such as ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate), ethyleneoxide modifications of these, vinylbenzene and derivatives thereof (such as 1,4-divinylbenzene, 4-vinylbenzoic acid-2-acryloylethyl ester, 1,4-divinyl cyclohexanone), vinylsulfones (such as divinylsulfone), acrylamides (such as methylenebisacrylamide) and methacrylamides. These monomers may be used in combination of 2 or more types.

Specific examples of the high refractive index monomer include bis(4-methacryloylthiophenyl)sulfide, vinylnaphthalene, vinylphenyl sulfide, 4-methacryloxyphenyl-4′-methoxyphenyl thioether. These monomers may also be used in combination of 2 or more types.

Polymerization of these monomers having an ethylenic unsaturated group can be effected by irradiation of ionizing radiation or heating in the presence of a photo radical initiator or thermal radical initiator. Accordingly, the antireflection layer can be formed by preparing a coating liquid containing a monomer having an ethylenic unsaturated group, a photo radical initiator or thermal radical initiator, mat particles and an inorganic filler, applying the coating liquid on the protective film followed by hardening the same through polymerization by ionizing radiation or heat. As these photo radical initiator and the like, publicly known ones can be employed.

As the polymer having polyether as the main chain, a ring-opened polymer of a polyfunctional epoxy compound is preferred. Ring-opening polymerization of a polyfunctional epoxy compound can be effected by irradiation of ionizing radiation or heating in the presence of a photo acid generator or thermal acid generator. Accordingly, the antireflection layer can be formed by preparing a coating liquid containing a polyfunctional epoxy compound, a photo acid generator or thermal acid generator, mat particles and an inorganic filler, applying the coating liquid on the protective film followed by hardening of the same through polymerization reaction by ionizing radiation or heat.

In place of a monomer having 2 or more ethylenic unsaturated groups, or in addition to it, a monomer having a crosslinkable functional group may be used to introduce the crosslinkable functional group into a polymer to introduce a crosslinked structure into the binder polymer through the reaction of the crosslinkable functional group.

Examples of the crosslinkable functional group include a isocyanate group, an epoxy group, an aziridine group, an oxazoline group, an aldehyde group, a carbonyl group, a hydrazine group, a carboxyl group, a methylol group and an active methylene group. Vinylsulfonic acid, acid anhydride, cyanoacrylate derivatives, melamine, etherified methylol, ester and urethane, and metal alkoxide such as tetramethoxy silane can also be utilized as a monomer for introducing a crosslinked structure. A functional group such as a blocked isocyanate group that shows crosslinkable property as the result of decomposition reaction may also be employed. That is, the crosslinkable functional group in the invention may be one that does not directly show reactivity but shows reactivity as the result of decomposition thereof.

The binder polymer having the crosslinkable functional group can form a crosslinked structure by heating after coating.

In the light scattering layer, for the purpose of giving it antiglare property, mat particles such as particles of an inorganic compound or resin particles having an average particle size of usually 1-10 μm, preferably 1.5-7.0 μm, which are larger than filler particles, are incorporated. Preferable specific examples of the mat particles include particles of inorganic compound such as silica particles and TiO₂ particles; and resin particles such as acrylic particles, crosslinked acrylic particles, polystyrene particles, crosslinked styrene particles, melamine resin particles and benzoguanamine resin particles. Among these, crosslinked styrene particles, crosslinked acrylic particles, crosslinked acrylic styrene particles and silica particles are preferred. Both of spherical and irregular-shaped mat particles can be used.

Two types or more of mat particles having different particle sizes may be used in combination. It is possible to give the layer antiglare property with mat particles having larger particle sizes and another optical property with mat particles having smaller particle sizes.

As to particle size distribution of the mat particles, monodispersion is most preferred, that is, the nearer particle size of respective particles the better. For example, when defining particles having particle sizes larger than the average particle size by 20% or more as coarse particles, the percentage of the coarse particles is preferably 1% or less, more preferably 0.1% or less, further preferably 0.01% or less of the total particle number. Mat particles having such particle size distribution can be obtained by classification after ordinary synthesis reaction. By increasing the number of times of classification or strengthening the degree thereof, a matting agent having more preferable distribution can be obtained.

The mat particles are incorporated in the light scattering layer so that the amount of the mat particles in the formed light scattering layer is preferably 10-1000 mg/m², more preferably 100-700 mg/m².

The particle size distribution of mat particles are measured with a Coulter counter method, and the measured distribution is converted to the distribution of particle number.

In the light scattering layer, in order to enhance the refractive index of the layer, an inorganic filler that is composed of an oxide of at least one metal selected from titanium, zirconium, aluminum, indium, zinc, tin and antimony and has an average particle size of 0.2 μm or less, preferably 0.1 μm or less, more preferably 0.06 μm or less is preferably incorporated in addition to the mat particles.

Adversely, in the light scattering layer using high refractive index mat particles, in order to keep the refractive index of the layer rather low, the use of an oxide of silicon is also preferred in order to make the difference of the refractive indices between the oxide and the mat particles. Preferable particle size is the same as that for the aforementioned inorganic filler.

Specific examples of the inorganic filler for use in the light scattering layer include TiO₂, ZrO₂, Al₂O₃, In₂O₃, ZnO, SnO₂, Sb₂O₃, ITO and SiO₂. TiO₂ and ZrO₂ are particularly preferred in point of increasing the refractive index. The surface of the inorganic filler is preferably subjected to silane coupling treatment or titanium coupling treatment. A surface treatment agent giving a functional group capable of reacting with the type of binder to the surface of the filler is preferably used.

The addition amount of these inorganic filler is preferably 10-90%, more preferably 20-80%, particularly preferably 30-75% of the total mass of the light scattering layer.

Since these fillers have such particle sizes that are sufficiently smaller than the wavelength of light, no scattering occurs, and a dispersed body formed by dispersing the filler in the binder polymer behaves as an optically homogeneous material.

The refractive index of a bulk mixture of the binder and the inorganic filler for the light scattering layer is preferably 1.50-2.00, more preferably 1.51-1.80. Suitable selection of the type and volume ratio of the binder and inorganic filler can result in the refractive index in the above-mentioned range. How to select these can be easily known previously on an experimental basis.

In order to assure surface evenness of the light scattering layer particularly free from coating unevenness, drying marks and point defects, the coating composition for forming the light scattering layer preferably contains either of fluorine-based or silicon-based surfactant, or both of these. In particular, a fluorine-based surfactant is preferably used because it exerts the effect of improving such surface troubles as coating unevenness, drying marks and point defects of the antireflection layer preferably used for the invention in a less addition amount. That is, it is preferred in point of capability of enhancing productivity by giving applicability for high-speed coating to the coating composition while improving the surface evenness of the layer.

(2) AR film

Next, the antireflection layer (AR film) formed by laminating a middle refractive index layer, a high refractive index layer and a low refractive index layer in this order will be described. These layers are preferably formed on the viewer side protective film.

The antireflection layer composed of the layer structure in the order of middle refractive index layer, high refractive index layer and low refractive index layer (outermost layer) is designed so as to have refractive indices satisfying the following relation:
refractive index of high refractive index layer>refractive index of middle refractive index layer>refractive index of protective film>refractive index of low refractive index layer

A hard coat layer may be provided between the protective film and the middle refractive index layer. Further, it may be composed of a middle refractive index hard coat layer, a high refractive index layer and a low refractive index layer. For example, antireflection layers described in JP-A-8-122504, JP-A-8-110401, JP-A-10-300902, JP-A-2002-243906 and JP-A-2000-111706 can be mentioned.

Furthermore, each layer may be given another function. For example, a low refractive index layer with antifouling property, a high refractive index layer with antistatic property (such as JP-A-10-206603, JP-A-2002-243906) can be mentioned.

The haze of the antireflection layer is preferably 5% or less, further preferably 3% or less. The surface hardness is preferably H or more, further preferably 2H or more, most preferably 3H or more, in the pencil hardness test according to JIS K-5400.

—High Refractive Index Layer and Middle Refractive Index Layer—

The layer having a high refractive index in the antireflection layer is composed of a hardened film containing at least fine particles of inorganic compound with a high refractive index having an average particle size of 100 nm or less, and a matrix binder.

As the fine particles of inorganic compound with a high refractive index, inorganic compounds with a refractive index of 1.65 or more can be mentioned, and those with a refractive index of 1.9 or more are preferred. For example, there can be mentioned an oxide of Ti, Zn, Sb, Sn, Zr, Ce, Ta, La or In, and complex oxides including these metal atoms.

These fine particles can be obtained by, for example, treating the surface of the particles with a surface treatment agent (e.g., silane coupling agent: JP-A-11-295503, JP-A-11-153703, JP-A-2000-9908, anionic compound or organic metal coupling agent: JP-A-2001-310432), forming a core shell structure with a core of a high refractive index particle (e.g., JP-A-2001-166104), or using a specified dispersing agent in combination (e.g., JP-A-11-153703, U.S. Pat. No. 6,210,858, JP-A-2002-277609).

As the material for forming the matrix, conventionally publicly known films of thermo plastic resin or thermosetting resin can be mentioned.

As further preferable materials, there can be mentioned at least one composition selected from a composition containing. a polyfunctional compound having 2 or more of at least either radical polymerizable group or cation polymerizable group, a compound containing an organic metal compound containing a hydrolyzable group, and a composition containing a partial condensate thereof. For example, compounds described in JP-A-2000-47004, JP-A-2001-315242, JP-A-2001-31871 and JP-A-2001-296401 can be mentioned.

A hardenable film obtained from a colloidal metal oxide obtained from a hydrolyzed condensate of metal alkoxide and a metal alkoxide composition is also preferred. For example, it is described in JP-A-2001-293818.

The refractive index of the high refractive index layer is preferably 1.70-2.20. The thickness of the high refractive index layer is preferably 5 nm-10 μm, more preferably 10 nm-1 μm.

The refractive index of the middle refractive index layer is adjusted so as to be a value between the refractive index of the low refractive index layer and the refractive index of the high refractive index layer. The refractive index of the middle refractive index layer is preferably 1.50-1.70. The thickness thereof is preferably 5 nm-10 μm, further preferably 10 nm-1 μm.

—Low Refractive Index Layer—

The low refractive index layer is laminated on the high refractive index layer in order. The refractive index of the low refractive index layer is preferably 1.20-1.55, more preferably 1.30-1.50.

The low refractive index layer is preferably built as the outermost layer having abrasion-resistant and antifouling property. As a means for significantly improving abrasion-resistant property, it is effective to give the surface lubricity. Such conventionally publicly known means for modifying a thin film layer as introduction of silicone or fluorine can be applied.

As the fluorine-containing compound, a compound including a crosslinkable or polymerizable functional group including fluorine atoms in the range of 35-80% by mass. For example, compounds described in JP-A-9-222503, paragraphs [0018]-[0026], JP-A-11-38202, paragraphs [0019]-[0030], JP-A-2001-40284, paragraphs [0027]-[0028], and JP-A-2000-284102 can be mentioned.

The refractive index of the fluorine-containing compound is preferably 1.35-1.50, more preferably 1.36-1.47.

As the silicone compound, preferred is a compound having a polysiloxane structure and containing a curable or polymerizable functional group in the polymer chain to have a bridged structure in the film. For example, reactive silicone (e.g., Silaplane, manufactured by CHISSO CORPORATION), and polysiloxane containing silanol groups at both ends (JP-A-11-258403) can be mentioned.

Crosslinking or polymerization reaction of at least any of fluorine-containing polymer and siloxane polymer having a crosslinkable or polymerizable group is preferably effected by applying a coating composition for forming the outermost layer containing a polymerization initiator, sensitizer etc. and, simultaneously or after the application, carrying out light irradiation or heating, thereby forming the low refractive index layer.

A sol/gel hardened film, which is obtained by hardening an organic metal compound such as a silane coupling agent and a silane coupling agent containing a specified hydrocarbon group containing fluorine through condensation reaction under the coexistence of a catalyst, is also preferred.

For example, polyfluoroalkyl group-containing silane compounds or partial hydrolysis condensates thereof (compounds described in JP-A-58-142958, JP-A-58-147483, JP-A-58-147484, JP-A-9-157582, JP-A-11-106704), silyl compounds containing a poly(perfluoroalkyl ether) group being a fluorine-containing long chain group (compounds described in JP-A-2000-117902, JP-A-2001-48590, JP-A-2002-53804) can be mentioned.

The low refractive index layer can contain, as additives other than those described above, a filler {e.g., low refractive index inorganic compounds such as silicon dioxide (silica), fluorine-containing particles (magnesium fluoride, calcium fluoride, barium fluoride) having an average primary particle diameter of 1-150 nm, organic fine particles described in JP-A-11-3820, paragraphs [0020]-[0038]}, silane coupling agent, lubricant and surfactant.

When the low refractive index layer lies under the outermost layer, the low refractive index layer may be formed by a vapor phase method (such as vacuum evaporation method, spattering method, ion plating method, plasma CVD method). In point of economical manufacture, a coating method is preferred.

The thickness of the low refractive index layer is preferably 30-200 nm, further preferably 50-150 nm, most preferably 60-120 nm.

—Hard Coat Layer—

In order to give physical strength to a protective film provided with an antireflection layer, the hard coat layer is preferably provided on the surface of the protective film. In particular, it is preferably provided between the protective film and the high refractive index layer. The hard coat layer is preferably formed through crosslinking reaction or polymerization reaction of a photo and/or thermosetting compound. As a curable functional group in the setting compound, a photo polymerizable functional group is preferred. Organic metal compounds or organic alkoxysilyl compounds containing a hydrolysable functional group are also preferred.

Specific examples of these compounds include the same compounds as those exemplified for the high refractive index layer.

As the specific constitutional composition for the hard coat layer, for example, those described in JP-A-2002-144913, JP-A-2000-9908 and WO 00/46617 can be mentioned.

The high refractive index layer can also act as the hard coat layer. In this case, it is preferred to form it by incorporating the hard coat layer with finely dispersed fine particles using the technique described for the high refractive index layer.

The hard coat layer can also act as an antiglare layer given the antiglare function by being incorporated with particles having an average particle size of 0.2-10 μm.

The thickness of the hard coat layer can be suitably designed in accordance with applications. The thickness of the hard coat layer is preferably 0.2-10 μm, more preferably 0.5-7 μm.

The surface strength of the hard coat layer is preferably H or more, further preferably 2H or more, most preferably 3H or more, in the pencil hardness test according to JIS K-5400. Further, a less wear volume of a test piece before and after the Tabor test according to JIS K-5400 is more preferred.

Backside Laminated Body

The backside laminated body of a liquid crystal display device can include a polarizing plate and, further, optical members to be adhered on the liquid crystal cell side and the backlight side of the polarizing plate.

According to need, an optical compensatory film is occasionally used on the liquid crystal cell side of the backside laminate body, and a diffusion sheet, brightness enhancing film and the like is occasionally used on the backlight side. Respective members may be adhered with each other by using an adhesive agent, which is also included in the backside laminated body. In this connection, in the case where a diffusion sheet, a brightness enhancing film or the like is disposed on the backlight side without being adhered directly with the backside polarizing plate, it is not included in the backside laminated body in the invention.

The optical compensatory film of the backside laminated body may be of a type having been integrated with the polarizing plate, the same one as described in the section of the foreside laminated body, or may be formed by laminating plural optical compensatory films. As optical compensatory films for lamination, mainly polymer films are preferably used. For example, a polymer film subjected to biaxial stretching in the plane direction to have birefringence, or a two-direction stretched film such as an inclined alignment polymer film which is uniaxially stretched in the plane direction and also in the thickness direction to control the refractive index in the thickness direction, is used. Furthermore, an inclined alignment film is also used. For example, one prepared by adhering a heat-shrinkable film to a polymer film and carrying out a stretching treatment and/or a contracting treatment under the action of the contraction force thereof by heating, or one prepared by obliquely aligning liquid crystal polymer, can be mentioned.

(Adhesive Agent)

Each of members constituting respective layers on the viewer side and the liquid crystal cell side are generally adhered with each other by using an adhesive layer including an adhesive agent. These adhesive layers can be formed by a suitable adhesive agent according to conventional one such as acrylic resin. From the viewpoint of preventing a foaming phenomenon or peeling phenomenon due to moisture absorption, and preventing lowering in optical performance due to the difference in thermal expansions, it is preferred that the adhesive layer has a low moisture absorptivity and an excellent heat resistance. An adhesive layer may be provided according to need. In the invention, for example, it may be provided for adhesion of the optical compensatory film and the protective film, and adhesion of the substrate and the foreside laminated body such as of the liquid crystal cell and the protective film, according to need.

In the liquid crystal display device of the invention, the thickness of the adhesive layer used upon laminating the foreside laminated body to the substrate is preferably 30 μm-100 μm, more preferably 33 μm-70 μm, further preferably 34 μm-50 μm.

As the material of the adhesive agent, pressure-sensitive adhesives such as a rubber-based adhesive, acrylic adhesive, silicone-based adhesive, urethane-based adhesive, polyether-based adhesive and polyester-based adhesive are preferred.

In the case of an acrylic adhesive, as monomer for use in acrylic polymer as the base polymer thereof, various types of (meth)acrylic acid esters [(meth)acrylic acid ester is the collective designation of acrylic acid ester and methacrylic acid ester; hereinafter, the name of compounds denoted with (meth) have the same meaning] can be used. Specific examples of the (meth)acrylic acid ester include methyl (meth)acrylate, ethyl (meth)acrylate, butyl (meth)acrylate, 2-ethylhexyl (meth)acrylate, and phenyl (meth)acrylate. These may be used independently or in combination. Further, in order to give the polarity to the acrylic polymer to be obtained, a small amount of (meth)acrylic acid may be used in place of a part of the (meth)acrylic acid ester. Furthermore, glycidyl (meth)acrylate, 2-hydroxyethyl (meth)acrylate, and N-methylol (meth)acrylamide may be also used in combination as a crosslinkable monomer. According to need, other copolymerizable monomer such as vinyl acetate and styrene may be also used in combination to an extent that does not degrade adhesive properties of the (meth)acrylic acid ester polymer.

Examples of the base polymer of rubber-based adhesive include natural rubber, isoprene-based rubber, styrene-butadiene-based rubber, regenerated rubber, polyisobutylene-based rubber, styrene-isoprene-styrene-based rubber, and styrene-butadiene-styrene-based rubber.

Examples of the base polymer of silicone-based adhesive include dimethyl polysiloxane and diphenyl polysiloxane.

Examples of the base polymer of polyether-based adhesive include polyvinylethyl ether, polyvinylbutyl ether and polyvinylisobutyl ether.

The adhesive for use in the invention can be prepared by, for example, blending (a) the base polymer with (b) a compound having a molecular weight of 100,000 or less. The ratio (a):(b) (mass ratio) is more preferably 90:10-20:80.

As (b) the compound having a molecular weight of 100,000 or less, one having a good compatibility with (a) the base polymer upon blending, optical transparency and the glass transition temperature (Tg) of 30° C. or more is preferred. For example, there can be mentioned one that has a mass average molecular weight of 100,000 or less and is similar to the base polymer, and that uses a large amount of component having a high Tg such as methyl (meth)acrylate as a monomer.

The adhesive for use in the invention can be incorporated with a crosslinking agent. As the crosslinking agent, polyisocyanate compounds, polyamine compounds, melamine resin, urea resin and epoxy resin can be mentioned.

Further, the adhesive for use in the invention can suitably use a tackifier, surfactant, filler, antioxidant, UV absorber or the like according to need in the range that does not deviate from the purpose of the invention. As these additives, one suitably selected from conventionally publicly known ones can be used.

The method for forming the adhesive layer is not particularly restricted. For example, such conventionally publicly known methods as a method of coating and drying an adhesive solution, and a method of transferring the adhesive layer using a release sheet provided with an adhesive layer can be mentioned.

The adhesive and method for forming the adhesive layer can be also used for other lamination, in addition to the case of laminating the foreside laminated body to the substrate. For example, it can be also used in such cases as laminating the backside laminated body to the substrate, adhering the optical compensatory film and the protective film, and adhering the liquid crystal cell and the protective film according to need.

(Panel)

In the invention, in order to more effectively prevent warpage of a panel and the corner unevenness of a liquid crystal display device due to the warpage, a system, in which the absorption axis of the polarizing plate on the foreside is laminated parallel to the short edge direction of the panel, is adopted.

The size of each layer for use in an image display device is equal to that of the panel (screen). The length of long edge thereof is preferably 10-500 cm from the viewpoint of a practical size and manufacturing, although it depends on the panel size of an image display device. It is more preferably 20-450 cm, further preferably 30-400 cm, particularly preferably 40-350 cm. There is no particular restriction on dimension thereof. However, since warpage of an liquid crystal panel becomes larger when the panel has a wider area, the use of the invention in particular for a liquid crystal display device having a large screen is effective.

The effect of the invention becomes larger when the ratio of the short edge to the long edge (short edge/long edge) is smaller, and the effect of the invention becomes remarkable when the value of short edge/long edge is 0.85 or less, in particular 0.7 or less.

(Warpage of Panel)

Warpage of a panel in the invention is measured according to such procedure that, after a panel is left at rest at a temperature of 50° C. and a relative humidity of 95% for 50 hours, it is moved into a circumstance of a temperature of 25° C. and a relative humidity of 60%, and then measurement is carried out after a time lapse of 20 minutes. The “warpage” is measured for a panel placed on a horizontal platform. Among panel exterior edges lifting from the horizontal platform due to the warpage, the height of the lift at the portion with the largest warpage is measured as a warpage quantity (mm). The warpage quantity w (mm) is divided by the length L (mm) in the long edge direction to give a warpage ratio (w/L). When the panel has a lateral size of 40 cm and a longitudinal size of 32 cm, the warpage ratio in the invention desirably satisfies w/L≦0.003, further desirably w/L≦0.0025.

(Image Display Device)

As described above, the image display device of the invention includes various types of image display devices such as a liquid crystal display device, an organic EL display device and a PDP.

A liquid crystal display device as one example of the image display device of the invention can be achieved by using liquid crystal cells with various display modes. As the display mode, various display modes have been proposed, including IPS (In-Plane Switching), VA (Vertical Aligned), TN (Twisted Nematic), OCB (Optically Compensated Bend), STN (Super Twisted Nematic), ECB (Electrically Controlled Birefringence), FLC (Ferroelectric Liquid Crystal), AFLC (Anti-ferroelectric Liquid Crystal) and HAN (Hybrid Aligned Nematic). Further, display modes obtained through alignment division of the above-described display modes are also proposed.

In the image display device of the invention, the use of liquid crystal display mode of the VA system or IPS system, or the use of liquid crystal display mode of the TN system or OCB system is preferred.

### EXAMPLES

Hereinafter, the characteristics of the present invention will be described more specifically on the basis of Examples and Comparative Examples. Material, use quantity, percentage, treatment content, treatment procedure and the like shown in the following Examples can be arbitrarily changed within a range that does not result in deviation from the purpose of the invention. Accordingly, the scope of the invention should not be construed restrictively by specific examples shown below.

### Example 1

(1) Manufacture of Protective Film

Each of 100 parts by mass of cellulose acetate having an acetyl-substituted degree of 2.86, 10 parts by mass of triphenyl phosphate (TPP), 400 parts by mass of methylene chloride (first solvent) and 60 parts by mass of methanol (second solvent) was put in a mixing tank and stirred to dissolve, thereby preparing a cellulose acetate solution. The cellulose acetate solution was filtered, which was cast on a metal support and conveyed while being held through a tenter zone at 100° C., then dried passing through a drying zone at 130° C. for 30 minutes to manufacture a transparent film sample 101. The formed transparent film 101 had a residual solvent amount of 0.2% or less and a film thickness of 80 μm. The aforementioned acetyl-substituted degree means the percentage of hydrogen atoms of hydroxyl groups at 2-, 3- and 5-sites of cellulose substituted by acetyl groups. The acetyl-substituted degree is 3 when all the hydrogen atoms of hydroxyl groups at 2-, 3- and 5-sites are substituted by acetyl groups.

The transparent film sample 101 was dipped in a 1.5 mol/L aqueous sodium hydroxide solution at 55° C. for 2 minutes. Then, it was washed in a water washing bath at room temperature, and neutralized with 0.1 mol/L sulfuric acid at 30° C. It was washed in a water washing bath at room temperature again, and further dried with hot air at 100° C. In this way, the surface of respective transparent films were surface-treated.

(2) Manufacture of Iodine-based Polarizing Plate

A roll-shaped polyvinyl alcohol film having a thickness of 80 μm was continuously stretched 5 times in an aqueous iodine solution and dried to give a polarizer having a thickness of 25 μm.

On both sides of the polarizer having a thickness of 25 μm, the aforementioned surface-treated transparent film sample 101 was laminated as a protective film with a polyvinyl alcohol-based adhesive to manufacture an iodine-based polarizing plate for the foreside (viewer side) and backside (back light side).

(3) Manufacture of Liquid Crystal Display Device

Next, on the foreside of an IPS type liquid crystal cell having a size of lateral long edge 40 cm and a longitudinal short edge 32 cm using a glass substrate having a thickness of 0.5 mm, the polarizing plate was laminated so that the direction of the absorption axis of polarizer of the polarizing plate became parallel to the short edge direction of the panel, and on the backside of the IPS type liquid crystal cell, the polarizing plate was laminated so that the absorption axis of polarizer of the polarizing plate crossed perpendicularly to the absorption axis of the foreside polarizing plate, via an acrylic adhesive having a thickness of 27 μm to manufacture a liquid crystal panel. The liquid crystal panel was mounted in a casing to manufacture a liquid crystal display device.

(4) Evaluation of Liquid Crystal Display Device Based on Wet Heat Treatment

The manufactured liquid crystal display device was left in a circumstance of temperature 50° C. and relative humidity 95% for 50 hours. After the treatment, it was directly moved into a circumstance of temperature 25° C. and relative humidity 60%. The power was turned on and the black display level was observed visually. Next, the panel alone was taken out of the liquid crystal display device, the warpage amount w of which was measured at a time lapse of 20 minutes from moving the same into the circumstance of temperature 25° C. and relative humidity 60%. By dividing the warpage amount w by the length L in long edge direction, the warpage ratio w/L (mm/mm) was obtained. As the result, the warpage ratio was 0.0026.

### Example 2

A liquid crystal panel was manufactured by laminating a polarizing plate manufactured in the same way as in Example 1 to the same IPS type liquid crystal cell as in Example 1 via an acrylic adhesive having a thickness of 30 μm so that the direction of the absorption axis of polarizer became in the same direction as in Example 1. The liquid crystal panel was mounted in a casing to manufacture a liquid crystal display device.

In the same way as Example 1, the manufactured liquid crystal display device was left in a circumstance of temperature 50° C. and relative humidity 95% for 50 hours. After the treatment, it was directly moved into a circumstance of temperature 25° C. and relative humidity 60%. The power was turned on and the black display level was observed visually. Next, the panel alone was taken out of the liquid crystal display device, the warpage amount w of which was measured at a time lapse of 20 minutes from moving the same into the circumstance of temperature 25° C. and relative humidity 60%. By dividing the warpage amount w by the length L in long edge direction, the warpage ratio w/L (mm/mm) was obtained. As the result, the warpage ratio was 0.0021. It was confirmed that no degradation of display due to the warpage was observed and it was at a level of no problem practically.

### Example 3

An IPS type liquid crystal display device was manufactured in the same way as in Example 1 except for replacing the viewer side protective film of foreside polarizing plate with one formed according to the following method.

(1) Manufacture of Viewer Side Protective Film of Foreside Polarizing Plate

The following composition was put in a mixing tank, which was stirred with heating to dissolve respective ingredients, thereby preparing a cellulose acetate solution.

<Composition of Cellulose Acetate Solution>

| | | |
|---|---|---|
| Cellulose acetate (acetylation degree: 60.9%) | 100 | parts by mass |
| Triphenyl phosphate (plasticizer) | 7.8 | parts by mass |
| Biphenyldiphenyl phosphate (plasticizer) | 3.9 | parts by mass |
| Methylene chloride (first solvent) | 300 | parts by mass |
| Methanol (second solvent) | 54 | parts by mass |
| 1-Butanol (third solvent) | 11 | parts by mass |

30 parts by mass of a retardation increasing agent below, 80 parts by mass of methylene chloride and 20 parts by mass of methanol were put in another mixing tank, which were stirred with heating to prepare a retardation increasing agent solution. To 474 parts by mass of the cellulose acetate solution, 30 parts by mass of the retardation increasing agent solution was mixed, which were sufficiently stirred to prepare a dope. The addition amount of the retardation increasing agent was 6.9 parts by mass relative to 100 parts by mass of the cellulose acetate.

Retardation Increasing Agent

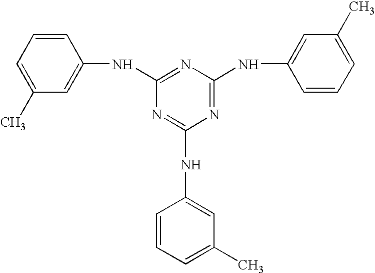

The obtained dope was cast using a band casting machine. A film containing a residual solvent of 15% by mass was laterally stretched at a draw ratio of 40% using a tenter at 130° C. to produce a cellulose acetate film sample 102 (thickness: 130 μm).

The retardation of the film was measured with an ellipsometer M-150 manufactured by JASCO Corporation to give 105 nm.

(2) Manufacture of Protective film Having Antireflection Layer

(2-1) Preparation of Coating Liquid for Light Scattering Layer

50 g of a mixture of pentaerythritol triacrylate and pentaerythritol tetraacrylate (PETA, manufactured by NIPPON KAYAKU CO., LTD.) was diluted with 38.5 g of toluene. Further, 2 g of a polymerization initiator (Irgacure 184, manufactured by Ciba Specialty Chemicals) was added, which were mixed and stirred. The refractive index of the coated film obtained by applying and UV-hardening the solution was 1.51.

Further, to the solution were added 1.7 g of a 30% by mass toluene dispersion liquid of closslinked polystyrene particles (SX-350, refractive index 1.60, manufactured by Soken Chemicka & Engineering Co., Ltd.) having an average particle size of 3.5 μm prepared by dispersing the particles with a POLYTRON dispersing machine at 10000 rpm, 13.3 g of a 30% by mass toluene dispersion liquid of crosslinked acryl-styrene particles (refractive index 1.55, manufactured by Soken Chemicka & Engineering Co., Ltd.) having an average particle size of 3.5 μm, and finally 0.75 g of a fluorine-containing surface modifier (FP-1 below) and 10 g of a silane coupling agent (KBM-5103, manufactured by Shin-Etsu Chemical Co., Ltd.). The obtained mixture liquid was filtered with a polypropylene filter having a pore size of 30 μm to prepare a coating liquid for a light scattering layer.
Fluorine-containing surface modifier (FP-1) 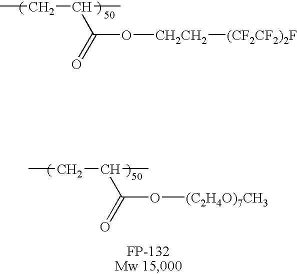
(2-2) Preparation of Coating Liquid for Low Refractive Index Layer

To a reaction vessel provided with a stirrer and a reflux condenser, 120 parts by mass of methylethyl ketone, 100 parts by mass of acryloyloxypropyl trimethoxysilane (KBM5103, manufactured by Shin-Etsu Chemical Co., Ltd.) and 3 parts by mass of diisopropoxyaluminum(ethyl acetoacetate) were added and mixed, and then 30 parts by mass of ion-exchanged water was added, which were reacted at 60° C. for 4 hours. Then the resultant was cooled to room temperature to give a sol liquid A. The mass average molecular weight was 1600, and among components not smaller than oligomer components, components having a molecular weight of 1000-20000 were 100% by mass. From the result of gas chromatography analysis, no acryloyloxypropyl trimethoxysilane being the raw material remained.

13 g of thermo crosslinkable fluorine-containing polymer having a refractive index of 1.42 (JN-7228, solid content concentration: 6% by mass, manufactured by JSR), 1.3 g of silica sol (silica, different from MEK-ST in particle size, average particle size: 45 nm, solid content concentration: 30% by mass, manufactured by NISSAN CHEMICAL INDUSTRIES, LTD.), 0.6 g of the sol liquid A prepared above, 5 g of methylethyl ketone, and 0.6 g of cyclohexanone were added, which were stirred and then filtered with a polypropylene filter having a pore diameter of 1 μm to prepare a coating liquid for the low refractive index layer.

(2-3) Application onto Protective Film

The manufactured film sample 102 was wound off in a roll shape, onto which the aforementioned coating liquid for functional layer (light scattering layer) was applied with a micro gravure roll with a diameter of 50 mm having a gravure pattern of line number 180 1/inch and depth 40 μm, and a doctor blade, under conditions of gravure roll rotation number 30 rpm and conveying speed 30 m/min. The coated layer was dried at 60° C. for 150 seconds, then hardened by irradiating ultraviolet rays having a lighting intensity of 400 mW/cm² and irradiation dosage of 250 mJ/cm² using an air-cooled metal halide lamp of 160 W/cm (manufactured by EYEGRAPHICS co., ltd.) under nitrogen purge to form a functional layer having a thickness of 6 μm, which was wound.

The triacetylcellulose film applied with the aforementioned functional layer (light scattering layer) was wound off again. On the light scattering layer side of the film, the coating liquid for low refractive index layer prepared above was applied with a micro gravure roll with a diameter of 50 mm having a gravure pattern of line number 180 1/inch and depth 40 μm, and a doctor blade, under conditions of gravure roll rotation number 30 rpm and conveying speed 15 m/min. The coated layer was dried at 120° C. for 150 seconds, and additionally at 140° C. for 8 minutes, then hardened by irradiating ultraviolet rays having a lighting intensity of 400 mW/cm² and irradiation dosage of 900 mJ/cm² using an air-cooled metal halide lamp of 240 W/cm (manufactured by EYEGRAPHICS co., ltd.) under nitrogen purge to form a low refractive index layer having a thickness of 100 nm, which was wound to manufacture a protective film having an antireflection layer (film sample 103).

(3) Manufacture of Foreside Polarizing Plate

The film sample 103 manufactured above was also subjected to the same surface treatment that was practiced for the transparent film sample 101 in Example 1.

A polarizer was manufactured in the same way as in Example 1, on the surface of which the film sample 103 having been subjected to the surface treatment was laminated as a viewer side protective film, and the surface treated film sample 101 manufactured in Example 1 was laminated as a cell side protective film, via a polyvinyl alcohol-based adhesive to manufacture a foreside polarizing plate.

In this case, the angle formed between the slow phase axis of the viewer side protective film and the absorption axis of the polarizer was set to become 45°.

(4) Manufacture of Liquid Crystal Display Device

By using the foreside polarizing plate manufactured above and the backside polarizing plate manufactured in Example 1, a liquid crystal display device was manufactured according to the following procedure.

Next, on the foreside of an IPS type liquid crystal cell having a size of lateral long edge 40 cm and a longitudinal short edge 32 cm using a glass substrate having a thickness of 0.5 mm, the polarizing plate was laminated so that the direction of the absorption axis of polarizer of the polarizing plate became parallel to the direction of the short edge of the panel, and on the backside of the IPS type liquid crystal cell, the polarizing plate was laminated so that the absorption axis of polarizer of the polarizing plate crossed perpendicularly to the absorption axis of the foreside polarizing plate, via an acrylic adhesive having a thickness of 30 μm to manufacture a liquid crystal panel. The liquid crystal panel was mounted in a casing to manufacture a liquid crystal display device.

(5) Evaluation of Liquid Crystal Display Device by Wet Heat Treatment

The manufactured liquid crystal display device was left in a circumstance of temperature 50° C. and relative humidity 95% for 50 hours. After the treatment, it was directly moved into a circumstance of temperature 25° C. and relative humidity 60%. The power was turned on and the black display level was observed visually. Next, the panel alone was taken out of the liquid crystal display device, the warpage amount w of which was measured at a time lapse of 20 minutes from moving the same into the circumstance of temperature 25° C. and relative humidity 60%. By dividing the warpage amount w by the length L in long edge direction, the warpage ratio w/L (mm/mm) was obtained. As the result, the warpage ratio was 0.0021.

Further, when the display screen of the image display device having the aforementioned constitution was observed closely, no particular problem was found in image display properties. Furthermore, when the display screen was observed with commercially available polarized glasses, there was also no such phenomenon that shade or interference color was found on the screen, or the whole screen was dark.

### Comparative Example 1

A liquid crystal panel was manufactured by laminating the polarizing plate manufactured in the same way as in Example to the same IPS type liquid crystal cell as in Example so that the direction of the absorption axis of polarizer of the polarizing plate became parallel to the long edge direction of the panel for the foreside, and that the absorption axis of polarizer of the polarizing plate crossed perpendicularly to the absorption axis of the foreside polarizing plate for the backside, via an acrylic adhesive having a thickness of 30 μm. The panel was mounted in a casing to manufacture a liquid crystal display device.

As was the case for Example, the manufactured liquid crystal display device was left in a circumstance of temperature 50° C. and relative humidity 95% for 50 hours. After the treatment, it was directly moved into a circumstance of temperature 25° C. and relative humidity 60%. The power was turned on and the black display level was observed visually. Next, the panel alone was taken out of the liquid crystal display device, the warpage amount w of which was measured at a time lapse of 20 minutes from moving the same into the circumstance of temperature 25° C. and relative humidity 60%. By dividing the warpage amount w by the length L in long edge direction, the warpage ratio w/L (mm/mm) was obtained. As the result, the warpage ratio was 0.0032, that is, larger than 0.003, and it was confirmed that corner unevenness and light leakage at four corners occurred caused by the warpage and the device was substantially at a useless level.

As described above, in the image display device of the invention, since warpage of the panel is prevented, the lowering in display performance can be suppressed effectively. Consequently, even under conditions with significant circumstance variations, excellent display performance can be maintained. Accordingly, the invention has a high industrial applicability.

The present disclosure relates to the subject matter contained in Japanese Patent Application No. 296216/2005 filed on Oct. 11, 2005 and Japanese Patent Application No. 068511/2006 filed on Mar. 14, 2006, which are expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. An image display device provided with a rectangular panel having a substrate composed of glass or resin, a foreside laminated body provided on the viewer side of the substrate and a backside laminated body provided on the backside of the substrate, wherein the foreside laminated body has a polarizer, and the absorption axis of the polarizer is parallel to the short edge direction of the panel.

2. The image display device according to claim 1 having a retardation film on the viewer side of the foreside laminated body.

3. The image display device according to claim 2, wherein a protective film provided on the viewer side of the foreside laminated body works as the retardation film.

4. The image display device according to claim 1 having at least one layer selected from the group consisting of an antiglare layer, a light scattering layer, a light-scattering antireflection layer and a light-scattering hard coat layer on the viewer side of the foreside laminated body.

5. The image display device according to claim 1, wherein the ratio of the short edge relative to the long edge (short edge/long edge) of the panel is 0.85 or less.

6. The image display device according to claim 1, wherein the long edge of the panel is within the range of 40 cm to 350 cm.

7. The image display device according to claim 1, wherein the foreside laminated body and the substrate are laminated via an adhesive layer and the thickness of the adhesive layer is within the range of 30 μm to 100 μm.

8. The image display device according to claim 1, wherein the surface of the panel on the viewer side is opened and the backside of the panel is closed with a casing.

9. The image display device according to claim 1, wherein the substrate is a liquid crystal cell and the backside laminated body includes an optical compensatory film.

10. The image display device according to claim 9, wherein the polarizer has a viewer side protective film provided on the viewer side and a substrate side protective film provided on the substrate side, and at least one of the viewer side protective film and the substrate side protective film is composed of cellulose acylate.

11. The image display device according to claim 1 employing the liquid crystal display mode of VA system or IPS system.

12. The image display device according to claim 1 employing the liquid crystal display mode of TN system or OCB system.
